(19) United States
(12) Patent Application Publication
(10) Pub. No.: US 2004/0141071 A1
(43) Pub. Date: Jul. 22, 2004

(54) Digital image recording device

(75) Inventor: Wen-Tsung Liu, HsinDian City (TW)

Correspondence Address: TROXELL LAW OFFICE PLLC, SUITE 1404, 5205 LEESBURG PIKE, FALLS CHURCH, VA, 22041, US

(73) Assignee: Carry Computer Eng. Co., Ltd.

(21) Appl. No.: 10/434,235

(22) Filed: May 9, 2003

(30) Foreign Application Priority Data
Jan. 16, 2003 (TW) 092200816

(51) Int. Cl. H04N 5/262

(52) U.S. Cl. 348/239

(57) ABSTRACT

A digital image recording device in which images are taken in different phases and can be coupled to form a panoramic photograph through a control unit with image processing software, including a main body, a lens, a display unit and a storage unit. The main body is designed to be rotatable relative to the lens for taking a photograph in different phases. A control unit with image processing software is set in the main body for combining the plurality of separate still images into a single panoramic photograph or panorama.

A digital image recording device comprises: a main body with a camera lens on the proper position, the camera lens is rotatable relative to the main body and can be used to take images in different phases; a control unit with image processing software which is installed inside the main body is used to take plurative still images and to connect them into a single image with panoramic view.

### THE TECHNICAL FIELD OF THE UTILITY MODEL

The present utility model is an image recording device, specifically, is a digital image recording device with the effect of taking panoramic view.

### THE PRIOR TECHNOLOGY

Camera is one of the important devices to record people's daily life and can be regarded as a diary, all images that you want to record can be recorded by using camera to keep a whole record; the earlier camera designs were mechanical structure, and the main components comprised a main body, an optical lens; a watching window that was set on the proper position of main body for watching the view that user would take, also a photosensitive film (the general film) allowed to be set in the main body for recording the view that user watched in the watching window in the film so that the photographs that recorded the views which user took previously were printed by using special chemistry preparation; however, the traditional cameras only can record the views that was taken previously in the film and display them through single printing method, it is impossible to display them directly by recording on the other recording media or materials; furthermore, it is impossible to watch the image that recorded in the film via the mechanical camera and to delete or modify the undesired or wrong images directly during taking period, these problems result in the wasting of film, also the sensitive films can not be reused after printing and the capacity of taking shot is very limited, thus cause the inconvenience and confusion on practical applying of taking photograph.

The important improvements to overcome these disadvantages have been made and the development trend is coming into digitalized and panoramic features of taking photograph so that taking photograph is becoming more convenience, therefore, digital camera which is the new products in the digital time is replacing the position of traditional camera in generally; the digital still camera comprising: a main body with a lens, a display unit and a storage unit; the lens is Charge Coupled Device (CCD) sensitive coupled component that takes the responsibility of inducing the light of image, display unit is a LCD, which is a new invention applying to digital camera, usually installed on the back of the camera, some of them can be rotatable in order to select the image at any angle, and most popular display units with many features are display units with 1.8 inches and 2 inches screen, it can be used to store, modify, delete and preview the image through the screen, the storage unit can be a flash memory or external memory card that is installed inside the main body for using to record image instead of traditional camera that records the image by negatives as a storage device without the limitation of the number of taking photograph as the negative has fixed 36 pieces of photographs on the film; digital camera takes photograph through lens as traditional camera does, the differences are: digital camera exams the color by CCD and converts the reflected back light into digital signals and compresses them to form image so as to be recorded in the memory device, moreover, the LCD that is set on the back of the main body allows the image to be viewed at real time from LCD, check and confirm whether the image is perfect so that the failure of exposal and absence of image can be avoided, and undesired images can be deleted at once from the camera in order to free the memory space of installed flash memory or external memory card. It is impossible for traditional camera and never wastes the negatives and saves the cost of print. From long term of view, the cost of taking photograph will be saved and the memory card can store and delete repeatedly, it is impossible for traditional mechanical camera to have the features.

Although digital camera has the advantages as described above, it only can take a single part of still image every time, it is impossible to take the panoramic image and record it. If user wants to obtain a panoramic image, the separated images that are taken at different phases need to be transferred to a computer through transfer interface in digitalized data, then user needs to overlap the repeated parts of these images by hand operation through using the image processing software of main body to obtain a panoramic image without any gaps. However, this operation for obtaining a panoramic image is inconvenient and makes user confuse. The disadvantages of prior technology of digital camera as described above has been disclosed, whereas there are still many problems that are not concerned in above descriptions.

For Example:

1. Whether the images that are taken in different phases using the digital camera can be coupled to directly form a panorama in the digital camera through the control unit with installed the image processing software.

2. Whether the digital camera can be designed to be rotatable so as to record the image that will be taken as separated images by means of rotatable recording image in different phases, and allow control unit of the device to connect the separate recorded images to form a panoramic photograph.

3. Whether the digital camera can be used to take photograph in rotatable different phases by an external rotatable device or instrument.

To overcome the disadvantages of existed digital camera that described as above, the inventor created the utility model to improve the prior designs.

### THE PURPOSE OF THE PRESENT UTILITY MODEL

The main purpose of the present utility model is to provide a digital image recording device which the images that are taken in different phases can be coupled to form a panoramic photograph through the control unit with installed the image processing software.

To achieve above goals, the present utility model provides a digital image recording device, it comprises: a main body, a lens, a display unit and a storage unit; the special character is: the main body can be designed to be rotatable relative to lens for taking photograph in different phases and a control unit with image processing software is set in the main body for combining the plurality of separate still images into single panoramic photograph or panorama.

Reference to the description according to the drawings as follows, the detailed structure, principal, features and effects can be understood roundly.

### THE PREFERABLE EMBODIMENT

Reference to FIG. 1, the present utility model comprising: a main body 1, a lens 2, a display unit 3 and a storage unit 4; wherein the lens 2 is set on the main body 1 for taking image, the display unit 3 and storage unit 4 are set on the main body at proper position, the recorded image can be viewed through the display unit 3 at the real time allowing user to check and confirm whether the image is desired so as to avoid the image absence, failure of exposal, and user can delete the undesired image from the digital camera at once. The storage unit 4 can be installed memory media or external connected electronic card for storing the recorded image data;

The main character of this present utility model is: a control unit 5 with image processing software is set in the main body, the plurality of separated still images that are recorded in different phases can be connected to form a single panoramic image without any gap by overlapping the repeated parts through the control unit 5 in the digital camera. Moreover, the lens 2 can be designed to be rotatable relative to the main body 1 so as to be operated by hand or automatically for taking still image at any angle in different phases.

Furthermore, the lens 2 is designed to be moveable in horizontal or vertical direction relative to the main body 1 allowing user to take the images such as skyscraper, light tower that buildings hit in air, cliff, waterfall of natural scenes and forester, playground, gorge with unlimited width etc. by means of taking the plurality of still images in different phases, and these images as above are connected in vertical or horizontal direction to form an image with unlimited width view by the control unit with image processing feature.

Moreover, the lens 2 can be designed to be rotatable at 360-degree in horizontal or vertical direction relative to main body 1, and user can easy to obtain an image with the effect of circular image at 360-degree from the images that are taken in different phases by hand operating or automatically rotating mode.

Farther, in this utility model, a rotatable part is set on the bottom of the main body 1, the connecting part 12 and/or locating part 13 are/is set on the rotatable part 11, a pre-set external device 6 (refer to FIG. 2), a connecting part 61 on the external device 6 for connecting with connecting part 12 of digital image recording device allow the recording device to keep stable status through the external device 6 so that the recording device can move in vertical, horizontal and/or 360-degree direction and take still images in different phases by means of hand operating or automatically rotating mode.

Again, locating unit 62 is set on the external device 6 for providing a convenient locating connecting means to connect the digital image recording device with the external device 6.

To sum up, the present utility model of the digital image recording device has truly realized the desired effort and designing consideration and had distinctive characters of the structure and applying features, and the present utility model is never disclosed to publics so that it satisfy the criterion for novelty. This application is proposed according to the related acts, it will be appreciated if this invention is granted paten right.

However, the description as above is only one of the preferred embodiments of the present utility model, any modification according to the spirit of the utility model resulting in the functional changes of these devices is the equal alternatives covered by the description and accompany drawing, and should not exceed the scope of the utility model

### THE BRIEF DESCRIPTION OF DRAWINGS:

FIG. 1 is a perspective view of the present utility model

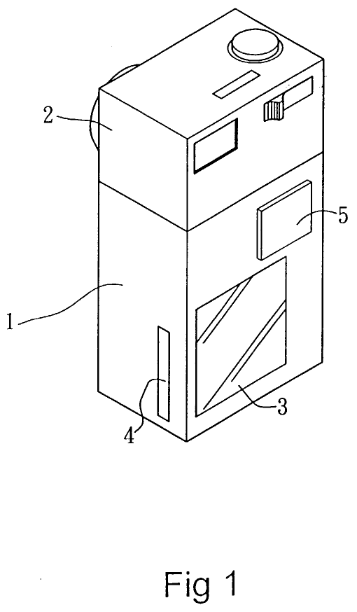

FIG. 2 is another embodiment's drawing of the present utility model.

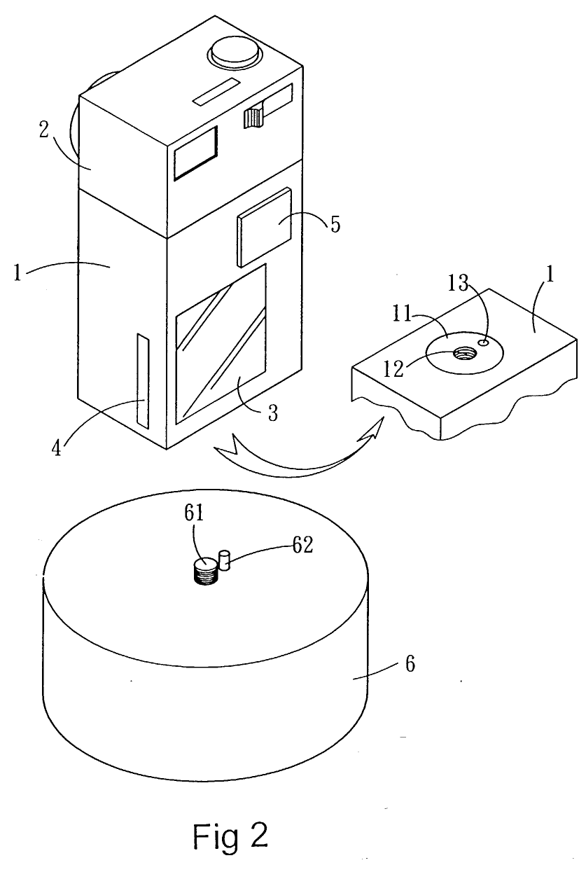

### THE ABBREVIATIONS OF THE COMPONENTS USED IN THE DRAWINGS:

1. Main body

2. Lens

3. Display unit

4. Storage unit

5. Control unit

6. Rotating device

11. Rotatable part

12. Couple part

13. Locating part

61. Connecting part

62. Locating unit

What is claimed is:

1. A digital image recording device comprising: a main body, a lens that is set on the main body, a display unit and a storage unit; wherein the character of the present utility model is: a control unit with installed image processing software in the main body for connecting the plurality of the still images that are taken in different phases into a single panoramic image.

2. The digital image recording device according to claim 1 wherein the lens is designed to be rotatable relative to the main body for taking images at any angle in different phases by means of hand operating or automatically rotating mode.

3. The digital image recording device according to claim 1 wherein the lens is designed to be moveable in horizontal or vertical direction relative to the main body.

4. The digital image recording device according to claim 1 wherein the lens also can be designed to be rotatable within 360-degree relative to the main body.

5. The digital image recording device according to claim 1 or 2 or 4 wherein a rotate part is set on the bottom of the main body, a couple part is set on the rotatable part for connecting an external device on the connect part.

6. The digital image recording device according to claim 1 or 5 wherein the rotatable part is designed to have an locating part.

7. The digital image recording device according to claim 5 wherein the external device can be designed to have an locating unit on it.
